(19) United States
(12) Patent Application Publication
(10) Pub. No.: US 2004/0219270 A1
(43) Pub. Date: Nov. 4, 2004

(54) Method of making mushroom based food product and food product made in accordance with the method

(75) Inventors: Donald P. Phillips, Kennett Square, PA (US); R. Marshall Phillips, Kennett Square, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Phillips Foods, Inc.

(21) Appl. No.: 10/829,779

(22) Filed: Apr. 22, 2004

Related U.S. Application Data
(60) Provisional application No. 60/466,968, filed on May 1, 2003.

(51) Int. Cl. A01G 1/04

(52) U.S. Cl. 426/518

(57) ABSTRACT

A mushroom based food product is made by cutting the cap portion of a mushroom along at least two generally parallel cut lines that are spaced apart by a predetermined distance. The cut lines are generally perpendicular to the stem portion of the mushroom and together form a generally cylindrically shaped mushroom slice. The mushroom slice has a circumference which corresponds to the circumference of the cap portion of the mushroom between the cut lines and has a thickness which corresponds to the predetermined distance.

### CROSS-REFERENCE TO RELATED APPLICATIONS

This application claims the benefit of U.S. Provisional Patent Application No. 60/466,968 filed May 1, 2003, and entitled “Method of Making Mushroom Based Food Product and Food Product Made in Accordance with the Method”.

### BACKGROUND OF THE INVENTION

The present invention relates generally to a method of making a food product from mushrooms as well as the food product which is produced using the method.

Mushrooms come in many varieties, shapes and sizes. However, most mushrooms are comprised of a cap portion which is generally circular with a domed top and a stem portion which is generally cylindrical. In the case of some types of mushrooms, like portabella mushrooms, the dimension or diameter of the cap portion greatly exceeds the dimension or diameter of the stem portion. With other mushrooms, the dimension or diameter of the cap portion is the same as or only slightly greater than the diameter or dimension of the stem portion.

The present invention comprises a method of making a food product from portabella and other mushrooms. The method described below may be used with portabella or other mushrooms of any size, shape or type to produce the food product. The present invention also comprises the food product which is produced in accordance with the method.

### BRIEF SUMMARY OF THE INVENTION

Briefly stated, the present invention comprises a method of making a food product from a mushroom having a cap portion and a stem portion the method comprising the steps of: cutting through the cap portion of the mushroom along a first cut line extending generally perpendicular to the stem portion; and cutting through the cap portion of the mushroom along a second cut line which is generally parallel to the first cut line and is spaced a predetermined distance from the first cut line to form a generally cylindrically shaped mushroom slice having a circumference which corresponds to the circumference of the cap portion of the mushroom between the first and second cut lines and a thickness which corresponds to the predetermined distance.

### BRIEF DESCRIPTION OF THE SEVERAL VIEWS OF THE DRAWING

The foregoing summary as well as the following detailed description of preferred embodiments of the invention will be better understood when read in conjunction with the appended drawing. For the purpose of illustrating the invention, there are shown in the drawing embodiments which are presently preferred. It should be understood, however, that the invention is not limited to the precise arrangements and instrumentalities shown.

In the drawing:

FIG. 1 is an elevational view of a typical whole portabella mushroom;

FIG. 2 is an elevational view of the portabella mushroom of FIG. 1 showing cut lines for performing the present method;

FIG. 3 is a perspective view of a mushroom product produced in accordance with the present invention; and

FIG. 4 is an elevational view of the mushroom product of FIG. 3.

### DETAILED DESCRIPTION OF THE INVENTION

Certain terminology is used in the following description for convenience only and should not be considered to be limiting. The words “right”, “left”, “lower”, and “upper” designate descriptions in the drawings to which reference is made. The words “inwardly and “outwardly” refer to directions toward and away from, respectively, the geometric center of the mushroom and mushroom based products and designated parts thereof. The terminology includes the words above specifically mentioned, derivatives thereof and words of similar import. Further, the use of the word “a” in the following specification is understood to mean “at least one”.

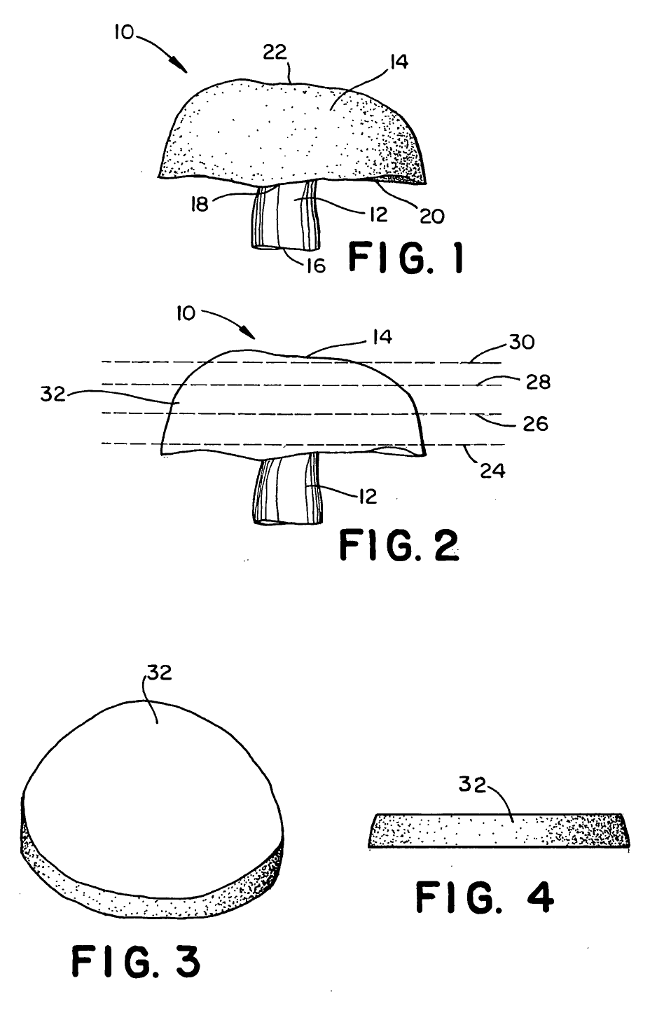

Referring to the drawing in detail, wherein like numerals indicate like elements throughout the several figures, there is shown in FIG. 1 a typical portabella mushroom 10 with which the present method may be used for producing a mushroom based food product. The mushroom 10 is typical of the type of mushrooms which are grown or otherwise obtained for consumption as food. The mushroom 10 includes a stem portion 12 and a cap portion 14. As shown in FIG. 1, the stem portion 12 is irregularly but generally cylindrically shaped with a first or distal end 16 and with a second end 18 which merges into the undersurface 20 of the cap portion 14. The generally cylindrical stem portion 12 has a diameter which, as will be appreciated by those of ordinary skill in the art, will vary depending upon the size and type of mushroom 10. Similarly, the length of the stem portion 12 from the first end 16 to the second end 18 will vary depending upon the size and type of the mushroom 10. It should be clearly understood by those of ordinary skill in the art that the present invention has equal applicability with respect to mushrooms having stem portions 12 of all lengths and diameters.

The cap portion 14, at least on the undersurface 20 which merges with the stem portion 12, is generally circular. In the portabella mushroom 10 illustrated in FIG. 1, the diameter of the undersurface 20 of the cap portion 14 is more than twice as great as the diameter of the stem portion 12. It is well known that the relative diameters of the stem portion 12 and undersurface 20 of the cap portion 14 of mushrooms vary substantially depending upon the size of the mushroom, the type of the mushroom and other factors. Accordingly, it should be clearly understood by those of ordinary skill in the art that the method of the present invention is not limited to use with mushrooms having a stem diameter to cap diameter which corresponds to that of the mushroom 10 shown in FIG. 1 and that the mushroom 10 is provided for the purpose of illustrating the present invention. Instead, it should be clearly understood that the present invention is fully applicable to all different types and sizes of mushrooms. The cap portion 14 further includes a generally dome-like upper surface 22 which, when combined with the stem portion 12 gives the mushroom 10 its classic mushroom shape. Again, it will be appreciated by those of ordinary skill in the art that the height, curvature and other parameters of the dome like surface 22 of the cap portion 14 will vary depending upon the size and type of mushroom. The present invention is applicable to mushrooms having dome-like upper surfaces of all different sizes and shapes.

The present invention comprises a method of making a mushroom based food product utilizing a mushroom, such as the portabella mushroom 10 as shown in FIG. 1. In order to make the mushroom based food product, the portabella mushroom 10 is effectively sliced longitudinally. More particularly, and referring to FIG. 2, there is shown the portabella mushroom 10 of FIG. 1 further including four generally parallel cut lines 24, 26, 28 and 30 extending longitudinally there-through. The cut lines are generally parallel to the undersurface 20 of the cap portion 14 and generally perpendicular to the stem portion 12. As shown in FIG. 2, the cut lines 24, 26, 28 and 30 are generally parallel to each other and are spaced apart by a predetermined distance. For purposes of illustrating the present invention, the predetermined distance between cut lines 28 and 30 is less than the predetermined distance between cut lines 28 and 26. Similarly, the predetermined distance between cut lines 28 and 26 is less than the predetermined distance between cut lines 26 and 24. It will be appreciated by those of ordinary skill in the art that the distance between the cut lines may be the same or may vary as shown in FIG. 2. It will also be appreciated by those of ordinary skill in the art that the number of cut lines may vary depending upon the type and size of the mushroom. For example, in the case of a portabella mushroom as shown in FIG. 2, three or more cut lines may be present whereas in the case of another mushroom only two cut lines may be present.

In performing the method of the present invention, the mushroom 10 is cut or sliced along each of the cut lines 24, 26, 28 and 30. The mushroom may be cut using a knife, wire cutter or any other suitable cutting device. Alternatively, the mushroom 10 may be cut utilizing a saw or other automated device. Each cut may be separately made or two or more of the cuts may be made simultaneously if desired. It will be appreciated by those of ordinary skill in the art that the particular device or equipment which is utilized in making the cuts along the cut line 24, 26, 28, 30 may vary in different applications.

Cutting the mushroom 10 along the cut lines, 24, 26, 28, 30 as shown in FIG. 2, results in three generally flat, generally cylindrical puck-like slices one of which is shown as 32 on FIGS. 3 and

4. The diameter of the puck-like slices 32 will vary depending upon the diameter of the cap portion 14 of the mushroom 10 and depending upon the position of the cap portion 14 from which each puck-like slice 32 has been removed. If desired, the puck-like slices 32 from a plurality of mushrooms may be separated and further processed by size. For example, puck-like slices 32 which come from the upper portion of the cap portion 14 of the mushroom 10 (i.e., the slice between cut lines 28 and 30)) and having a first diameter could be grouped with slices 32 from other mushrooms having the same or substantially the same diameter. As suggested above, the thickness of the puck-like slices 32 may also vary depending upon the spacing between the cut lines 24, 26, 28, and 30. It is also envisioned that puck-like slices 32 having a similar thickness could also be grouped together.

The puck-like slices 32 can thereafter be further processed for use in many applications. For example, puck-like slices 32 could be breaded and fried, coated with parmesan cheese or some other cheese or topping and cooked (baked, broiled, grilled, microwaved or the like) or otherwise cooked (grilled, broiled, baked, microwaved, etc.) and served similar to a cheeseburger. The puck-like slices 32 can be sized to fit a roll or to otherwise fit a particular desired diameter. If desired, the puck-like slices 32 may be used as a low carb replacement for bread or a roll in making a sandwich.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method of making a food product from a mushroom having a cap portion and a stem portion the method comprising the steps of:
cutting through the cap portion of the mushroom along a first cut line extending generally perpendicular to the stem portion; and
cutting through the cap portion of the mushroom along a second cut line which is generally parallel to the first cut line and is spaced a predetermined distance from the first cut line to form a generally cylindrically shaped mushroom slice having a circumference which corresponds to the circumference of the cap portion of the mushroom between the first and second cut lines and a thickness which corresponds to the predetermined distance.

2. The method as recited in claim 1 wherein the first and second cuts are made simultaneously.

3. The method as recited in claim 1 further comprising cooking the cylindrically shaped mushroom slice.

4. The method as recited in claim 3 wherein the cooking step consists of at least one of baking, broiling, grilling, frying and microwaving.

5. The method as recited in claim 3 where prior to the cooking step the mushroom slice receives a coating.

6. A mushroom food product made in accordance with the method of claim 1.
